(19) United States
(12) Patent Application Publication
(10) Pub. No.: US 2025/0147483 A1
(43) Pub. Date: May 8, 2025

(54) INTEGRATED GENERATIVE AI FRAMEWORK FOR ANALYTICS USING HMI ASSISTANCE

(71) Applicant: Rockwell Automation Technologies, Inc., Mayfield Heights, OH (US)

(72) Inventors: Nikhil Ashok Patange, Pune (IN); Dennis J. Luo, Germantown, WI (US); Ankan Chowdhury, Pimpri-Chinchwad (IN); Meiling He, Shorewood, WI (US); Fatime Ly Seymour, Charlotte, NC (US); Francisco P. Maturana, Lyndhurst, OH (US); Tasha Markovich, North Royalton, OH (US); Scott M. Thomas, West Chester, OH (US)

(21) Appl. No.: 18/503,913

(22) Filed: Nov. 7, 2023

(51) Int. Cl. G05B 19/409; G05B 19/4063

(52) U.S. Cl. CPC G05B 19/409; G05B 19/4063; G05B 2219/36133

(57) ABSTRACT

A method may include receiving, via a processing system, a request for information associated with an industrial automation system from a user, identifying a prompt associated with the request, and identifying one or more datasets associated with the request based on the prompt and the information. The method may also involve receiving the one or more datasets from one or more data sources, formatting the request and the one or more datasets into a package, and sending the package to a generative artificial intelligence (AI) system. The method may then involve receiving a response from the generative AI system, such that the response may be presented via a display of a human machine interface (HMI) system.

### CROSS-REFERENCE TO RELATED APPLICATION

This application is related to U.S. patent application Ser. No.______ entitled “Employing a Batch Model in Root Cause Analysis of Industrial Batch Performance Analytics,” and U.S. patent application Ser. No.______, entitled “Root Cause Analysis Framework in Industrial Process Analytics,” each of which is herein incorporated by reference in their entirety for all purposes.

### BACKGROUND

This disclosure generally relates to industrial automation systems and, more particularly, to providing a root cause analysis framework for analyzing industrial process data.

In industrial automation systems, anomalies, faults, and other errors may occur for a number of reasons. However, traditional methods for performing root cause analysis to identify causes for these issues may prove to be challenging with respect to time to resolve the issues and the number of resources employed in the processes. With this in mind, it may be beneficial to leverage data provided by industrial devices (e.g., operational technology (OT) devices) to perform more efficient data analytics to perform root cause analysis in a consistent manner.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, A method may include receiving, via a processing system, a request for information associated with an industrial automation system from a user, identifying a prompt associated with the request, and identifying one or more datasets associated with the request based on the prompt and the information. The method may also involve receiving the one or more datasets from one or more data sources, formatting the request and the one or more datasets into a package, and sending the package to a generative artificial intelligence (AI) system. The method may then involve receiving a response from the generative AI system, such that the response may be presented via a display of a human machine interface (HMI) system.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 is a diagrammatic representation of an example petrochemical-related process, in accordance with an embodiment;

FIG. 2 is an illustration of an industrial automation system that includes a distributed control system (DCS), in accordance with an embodiment;

FIG. 3 is an illustration of a human machine interface (HMI) system, in accordance with an embodiment;

FIG. 4 is an industrial generative artificial intelligence (AI) platform in which the HMI interacts with data acquired by industrial automation components and a generative AI system, in accordance with an embodiment; and

FIG. 5 is a flow chart of a method for packaging requests to a generative AI system via the generative AI platform of FIG. 4, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Industrial automation systems are generating vast quantities of data that may be overwhelming to analyze. Compounding these challenges is the inadequate visualization tools available to provide clear and real-time feedback useful for rapid comprehension and decision-making. Moreover, many existing systems suffer from limited accessibility, thereby hindering prompt and efficient information retrieval. In sum, there is a challenge to program and quickly create a list of investigative visualizations that can aid in the identification of root causes in datasets, execute real-time analysis on connected data impedes prompt decision-making, and effectively integrate with human machine interface (HMI) systems and tools.

With the foregoing in mind, in certain embodiments, a human machine interface (HMI) system may use generative artificial intelligence (AI) algorithms to deliver precise and contextually relevant responses to user inquiries concerning the operations of the respective industrial automation systems. In some embodiments, the HMI system may employ a LangChain framework to underpin the generative AI, facilitate dynamic chart generation based on AI completions, and the like to derive actionable insights from the datasets provided by or concerning the industrial automation systems. In addition, the HMI system may provide a prompt library to provide augmentable prompts tailored for executing transaction cost analysis (TCA) analytics.

By way of operation, the HMI system may receive historical data via data sources (e.g., FT DataMosaix) or real time data via industrial automation components (e.g., via FT Otpix). These datasets may be parsed or packaged using the LangChain framework with prompts provided by a prompt engine in a generative pre-trained transformer (GPT) backplane that may interface with a generative AI system to provide real-time generative AI feedback for provided prompts. In this way, the generative AI system may be focused on the datasets and prompts provided by the GPT backplane to efficiently provide responses in a context suitable for the user in the industrial environment. As a result, the HMI system may allow users to efficiently interact and query the generative AI system to glean discernable information related to the industrial datasets and provide information related to root cause analysis therein.

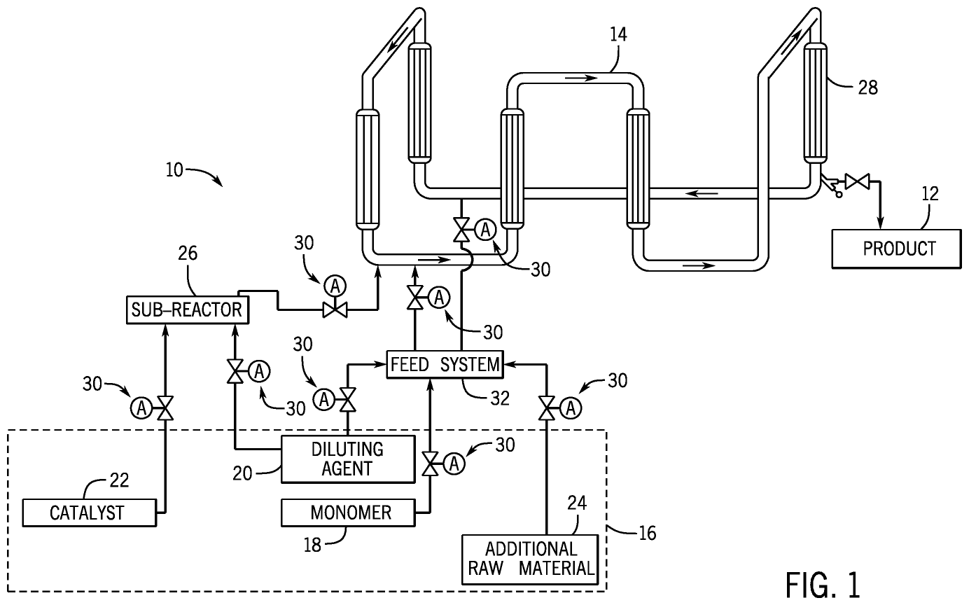

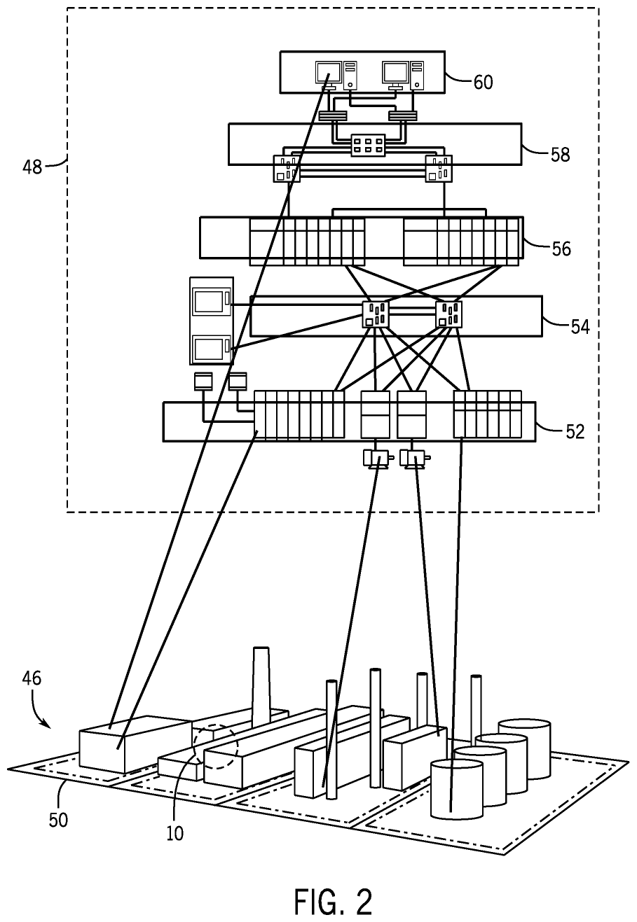

By way of introduction, FIG. 1 is a diagrammatic representation of a petrochemical-related process in which embodiments described below may be implemented. In particular, illustrated is an example reactor system 10, such as a polymerization reactor capable of processing olefin monomers, like ethylene or hexene, to produce homopolymers or co-polymers as products 12. Any suitable reactor may be used, including batch, slurry, gas-phase, solution, high pressure, tubular or autoclave reactors, or any combination thereof. For ease of discussion, FIG. 1 refers to a loop reactor 14 for polymerization. However, it should be noted that the discussion set forth below is intended to be applicable, as appropriate, to any petrochemical process, industrial process, manufacturing process, or the like, as a way to provide context to the following discussion of FIGS. 2-5.

Production processes, like the polymerization reactor process shown in FIG. 1, may occur on an ongoing basis as part of a continuous operation to generate products (e.g., product 12). Sometimes a variety of both continuous and batch systems may be employed throughout a production process. Various suppliers may provide reactor feedstocks 16 to the reactor system 10 via pipelines, trucks, cylinders, drums, and so forth. The suppliers may include off-site and/or on-site facilities, including olefin plants, refineries, catalyst plants, on or off-site laboratories, and the like. Examples of possible feedstocks 16 include olefin monomers 18, diluents or diluting agents 20, catalysts 22, and/or other additives. The other feed components, additional raw materials 24, may also be provided to the reactor 14. Feedstocks 16 may change when using different manufacturing processes and/or when manufacturing a different final product. The feedstocks 16 may be stored or processed in any suitable vessel or process, such as in monomer storage and feed tanks, diluent vessels, catalyst tanks, co-catalyst cylinders and tanks, treatment beds like molecular sieve beds and/or aluminum packing, and so forth, prior to or after being received at the reactor system 10. The reactor system 10 may include one type of reactor in a system or multiple reactors of the same or different type, and desired processing conditions in one of the reactors may be different from the operating conditions of the other reactors.

The product 12 may be moved from the reactor system 10 for additional processing, such as to form polymer pellets from the product 12. In general, the product 12, or processed product (e.g., pellets) may be transported to a product load-out area for storage, blending with other products or processed products, and/or loading into railcars, trucks, bags, ships, and so forth, for distribution to customers.

Processes, like the reactor system 10, may receive or process feedstocks 16 at relatively high pressures and/or relatively high temperatures. For example, a hydrogen feedstock may be handled by the reactor system 10 via pipeline at approximately 900-1000 pounds per square inch gauge (psig) at psig at 90-110° F. Furthermore, some products may be generated using highly reactive, unstable, corrosive, or otherwise toxic materials as the feedstock 16 or as intermediate products, such as hydrogen sulfide, pure oxygen, or the like. Heat, pressure, and other operating parameters may be employed appropriately to obtain appropriate reaction conditions, which may increase a reactivity, instability, or corrosive nature of the feedstock 16. These materials may be desired to be processed and transported using reliable and highly available systems, for example, to reduce a likelihood of a release event from occurring.

Each of the feedstocks 16, sub-reactor 26, and/or feed system 32 may use different operating parameters to create suitable output intermediate products for use in subsequent reactions or as a product output. Operating parameters of the reactor system 10 may include temperature, pressure, flow rate, mechanical agitation, product takeoff, component concentrations, polymer production rate, and so forth, and one or more may be selected on to achieve the desired polymer properties. Controlling temperature may include using a gas burner, an electrical heating conduit, a heat exchange device 28, or the like, to increase or reduce the temperature of intermediate products of the reactor system 10. As an example, during operation, a cooling fluid may be circulated within the cooling jackets of the heat exchange devices 68 as needed to remove the generated heat and to maintain the temperature within the desired range, such as between approximately 150° F. to 250° F. (65° C. to 121° C.) for polyethylene.

Feedstock 16 flow rates, control of operating parameters, and the like, may be managed by a control system (e.g., like the control system shown in FIG. 2). The control system may generate control signals, for example, control signals that are transmitted to one or more actuators 30 to cause the actuator to open or close (or partially open or partially close) as a way to control operating parameters of the feedstock 16, control of other operating parameters, and the like. Care may be taken when adjusting operating parameters since petrochemical manufacturing processing may be highly sensitive to erroneous operation. For example, fractions of a percentage of reliability change in a control system of the reactor system 10 may make a difference between a process being taken offline or a process working as expected.

With the foregoing in mind, the components of the reactor system 10 may be connected to power supplies, power supply conditions, and other systems that enable the components to be highly available. Moreover, it should be noted that the present embodiments described herein may be implemented in a variety of industrial environments and should not be limited to the reactor system 10 described above.

Referring now to FIG. 2, FIG. 2 is an illustration of an example industrial automation system 46 that includes a distributed control system 48 (e.g., a “DCS”). The industrial automation system 46 may include the reactor system 10 from FIG. 1 and/or any number of industrial automation components.

Industrial automation components may include a user interface, the distributed control system 48, a motor drive, a motor, a conveyor, specialized original equipment manufacturer machines, fire suppressant system, and any other device that may enable production or manufacture products or process certain materials. In addition to the aforementioned types of industrial automation components, the industrial automation components may also include controllers, input/output (IO) modules, motor control centers, motors, human-machine interfaces (HMIs), user interfaces, contactors, starters, sensors, drives, relays, protection devices, switchgear, compressors, network switches (e.g., Ethernet switches, modular-managed, fixed-managed, service-router, industrial, unmanaged), and the like. The industrial automation components may also be related to various industrial equipment such as mixers, machine conveyors, tanks, skids, specialized original equipment manufacturer machines, and the like. The industrial automation components may also be associated with devices used in conjunction with the equipment such as scanners, gauges, valves, and the like. In one embodiment, every aspect of the industrial automation component may be controlled or operated by a single controller (e.g., control system). In another embodiment, the control and operation of each aspect of the industrial automation components may be distributed via multiple controllers (e.g., control system).

The industrial automation system 46 may divide logically and physically into different units 50 corresponding to cells, areas, factories, subsystems, or the like of the industrial automation system 46. The industrial automation components (e.g., load components, processing components) may be used within a unit 50 to perform various operations for the unit 50. The industrial automation components may be logically and/or physically divided into the units 50 as well to control performance of the various operations for the unit 50.

The distributed control system 48 may include computing devices with communication abilities, processing abilities, and the like. For example, the distributed control system 48 may include processing modules, a control system, a programmable logic controller (PLC), a programmable automation controller (PAC), or any other controller that may monitor, control, and operate an industrial automation device or component. The distributed control system 48 may be incorporated into any physical device (e.g., the industrial automation components) or may be implemented as a stand-alone computing device (e.g., general purpose computer), such as a desktop computer, a laptop computer, a tablet computer, a mobile device computing device, or the like. For example, the distributed control system 48 may include many processing devices logically arranged in a hierarchy to implement control operations by disseminating control signals, monitoring operations of the industrial automation system 46, logging data as part of historical tracking operations, and so on.

In an example distributed control system 48, different hierarchical levels of devices may correspond to different operations. A first level 52 may include input/output communication modules (IO modules) to interface with industrial automation components in the unit 50. A second level 54 may include control systems that control components of the first level and/or enable intercommunication between components of the first level 52, even if not communicatively coupled in the first level 52. A third level 56 may include network components, such as network switches, that support availability of a mode of electronic communication between industrial automation components. A fourth level 58 may include server components, such as application servers, data servers, human-machine interface servers, or the like. The server components may store data as part of these servers that enable industrial automation operations to be monitored and adjusted over time. A fifth level 60 may include computing devices, such as virtual computing devices operated from a server to enable human-machine interaction via an HMI presented via a computing device. It should be understood that levels of the hierarchy are not exhaustive and nonexclusive, and thus devices described in any of the levels may be included in any of the other levels. For example, any of the levels may include some variation of an HMI.

One or more of the levels or components of the distributed control system 48 may use and/or include one or more processing components, including microprocessors (e.g., field programmable gate arrays, digital signal processors, application specific instruction set processors, programmable logic devices, programmable logic controllers), tangible, non-transitory, machine-readable media (e.g., memory such as non-volatile memory, random access memory (RAM), read-only memory (ROM), and so forth. The machine-readable media may collectively store one or more sets of instructions (e.g., algorithms) in computer-readable code form, and may be grouped into applications depending on the type of control performed by the distributed control system 48. In this way, the distributed control system 48 may be application-specific, or general purpose.

Furthermore, portions of the distributed control system 48 may be a or a part of a closed loop control system (e.g., does not use feedback for control), an open loop control system (e.g., uses feedback for control), or may include a combination of both open and closed system components and/or algorithms. Further, in some embodiments, the distributed control system 48 may utilize feed forward inputs. For example, depending on information relating to the feedstocks 16 (e.g., compositional information relating to the catalyst 22 and/or the additional raw material 24, the distributed control system 48 may control the flow of any one or a combination of the feedstocks 16 into the sub-reactor 26, the reactor 14, or the like.

Each of the levels 52, 54, 56, 58, 60 may include component redundancies, which may help provide a high availability control system. For example, within the first level, redundant and concurrently operating backplanes may provide power to each of the IO modules.

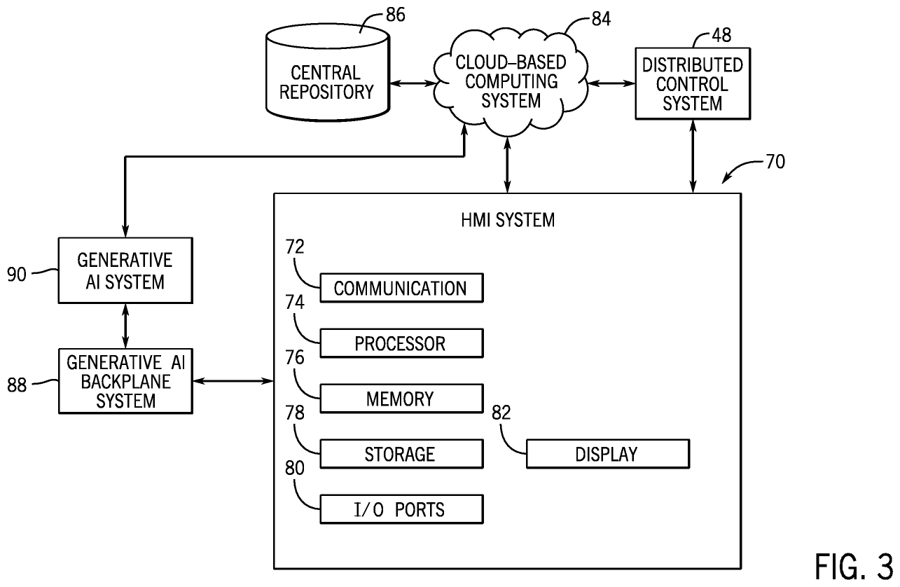

In any case, data collected from the distributed control system 48, stored in a central repository, or the like may be made available to a human machine interface (MHI) system 70. FIG. 3 illustrates example components that may be part of the HMI system 70, in accordance with embodiments presented herein. For example, the batch optimizer system 70 may include a communication component 72, a processor 74, a memory 76, a storage 78, input/output (I/O) ports 80, a display 82, and the like. The communication component 72 may be a wireless or wired communication component that may facilitate communication between the industrial automation component that may be part of the distributed control system 48, a cloud-based computing system 84, a central repository 86 and other communication capable devices.

In some embodiments, the cloud-based computing system 84 may host a number of services via computing system resources that may be distributed over multiple locations. In this way, the various computing system resources may be scaled as needed to perform various operations. In some embodiments, the HMI system 70 may be implemented via the cloud-based computing system 84, as a separate computing system, or both.

Further, datasets acquired via the industrial automation components, the distributed control system 48, or the like may be stored in the central repository 86. In addition, the simulated datasets acquired by digital twin systems that mirror or simulate the operations of an industrial automation system may be included in the central repository 86. In any case, the central repository 86 may include one or more databases or data structures for storing and querying datasets in a structured and efficient manner. In addition, the results of the root cause analysis operations performed by the HMI system 70 and described herein may be stored in the central repository 86, such that previously performed analysis operations may be reviewed, modified, and redeployed for different datasets.

The processor 74 may be any type of computer processor or microprocessor capable of executing computer-executable code. The processor 74 may also include multiple processors that may perform the operations described below. The memory 76 and the storage 78 may be any suitable articles of manufacture that can serve as media to store processor-executable code, data, or the like. These articles of manufacture may represent computer-readable media (e.g., any suitable form of memory or storage) that may store the processor-executable code used by the processor 74 to perform the presently disclosed techniques. Generally, the processor 74 may execute software applications that include programs that enable a user to perform root cause analysis on accessible datasets to better ascertain issues or solutions to various discrepancies, anomalies, or the like. That is, the software applications may communicate with the HMI system 70 may gather information associated with operations the industrial automation components via the sensors disposed on the industrial automation components and provide a user interface visualization to enable a user to perform different types of root cause analysis on the collected data, interact with generative artificial intelligence (AI) systems, and the like.

The memory 76 and the storage 78 may also be used to store the data, analysis of the data, the software applications, and the like. The memory 76 and the storage 78 may represent non-transitory computer-readable media (e.g., any suitable form of memory or storage) that may store the processor-executable code used by the processor 74 to perform various techniques described herein. It should be noted that non-transitory merely indicates that the media is tangible and not a signal.

In one embodiment, the memory 76 and/or storage 78 may include a software application that may be executed by the processor 74 and may be used to monitor, control, access, or view one of the industrial automation components. As such, the HMI system 70 may communicatively couple to industrial automation components or to a respective computing device of the industrial automation components via a direct connection between the devices, via the cloud-based computing system 84, or the like.

The I/O ports 80 may be interfaces that may couple to other peripheral components such as input devices (e.g., keyboard, mouse), sensors, input/output (I/O) modules, and the like. I/O modules may enable the HMI system 70 to communicate with the industrial automation components or other devices in the industrial automation system via the I/O modules.

The display 82 may depict visualizations associated with software or executable code being processed by the processor 74. In one embodiment, the display 82 may be a touch display capable of receiving inputs from a user of the HMI system 70. As such, the display 82 may serve as a user interface to provide parameters and instructions to guide the operation of the HMI system 70. The display 82 may be used to display a graphical user interface (GUI) for operating the HMI system 70. The display 82 may be any suitable type of display, such as a liquid crystal display (LCD), plasma display, or an organic light emitting diode (OLED) display, for example. Additionally, in one embodiment, the display 82 may be provided in conjunction with a touch-sensitive mechanism (e.g., a touch screen) that may function as part of a control interface for the industrial automation components to control the general operations of the system 10 or the like.

Although the components described above have been discussed with regard to the HMI system 70, it should be noted that similar components may make up other computing devices described herein. Further, it should be noted that the listed components are provided as example components and the embodiments described herein are not to be limited to the components described with reference to FIG. 3.

In addition to communicating with the cloud-based computing system 84, the central repository 86, and the distributed control system 48, the HMI system 70 may also communicate with a generative AI backplane system 88 and a generative AI system 90. The generative AI backplane system 88 and the generative AI system 90 may operate independently, be hosted by the cloud-based computing system 84, and the like. In any case, the generative AI backplane system 88 may interface or interact with the generative AI system 90 to retrieve generative AI responses and feedback related to user inputs (e.g., inquiries) regarding the operations of the industrial automation system, industrial automation components, and the like.

By way of example, the generative AI system 90 may include any suitable generative AI technology, such as generative pre-trained transformer (GPT) 3, 4, and the like. As such, the generative AI system 90 may include a deep neural network model that has been trained on text data from various sources (e.g., internet). The generative AI system 90 may perform natural language processing tasks, such that received inquiries may be processed and natural language response may be provided in response to the inquiries. By way of example, the generative AI system 90 may employ a transformer architecture (e.g., neural network architecture) that uses an encoder to process an input sequence of tokens that may be processed in parallel (e.g., simultaneously) to provide a continuous vector representation of relationships between tokens (e.g., words in inquiries). The generative AI system 90 may also include a decoder that may generate an output sequence of tokens based on the encoded input. The decoder may take context from the encoder and generate output tokens using a model (e.g., autoregressive model).

With this in mind, the generative AI system 90 may be pre-trained on a wide variety of publicly available data, but it may lack the ability to provide contextual answers for propriety datasets, such as the data acquired by the industrial automation components, the distributed control system 48, and the like. That is, these data sources are secured via firewall, encryption, and other security measure to ensure that proprietary datasets and processes are not shared with competitors or the general public. In this way, the generative AI system 90 may not be capable of providing accurate responses to inquiries that are related to proprietary datasets that it may not be able to or may be prohibited from accessing.

In some embodiments, the generative AI backplane system 88 may enable the generative AI system 90 to interface or access proprietary datasets to provide generative responses that are contextualized with respect to the respective industrial system. Indeed, the HMI system 70 may facilitate the communication between the generative AI backplane system 88, the generative AI system 90, the various industrial data sources, and the user to provide a generative AI tool that the user may use to obtain real-time feedback responses. However, since the generative AI system 90 is not pre-trained on the datasets related to the industrial system, the generative AI backplane system 88 may package or process the industrial datasets related to an inquiry received via the HMI system 70, such that the generative AI system 90 may efficiently process the packaged dataset and apply its language model with respect to the industrial datasets to provide relevant answers to the inquiries. Moreover, in some embodiments, the generative AI backplane system 88 may encrypt or encode the datasets using some encryption process, such that the responses provided by the generative AI system 90 may initially provide pseudo responses that the generative AI backplane system 88 may decode and provide to the user via the HMI system 70 to ensure that the proprietary industrial datasets is not shared in raw form to the generative AI system 90.

With the foregoing in mind, in some embodiments, the HMI system 70 may enable users to perform root cause analysis and reference batch analysis as described in U.S. patent application Ser. No.______, entitled, “ROOT CAUSE ANALYSIS FRAMEWORK IN INDUSTRIAL PROCESS ANALYTICS” and U.S. patent application Ser. No.______, entitled, “EMPLOYING A BATCH MODEL IN ROOT CAUSE ANALYSIS OF INDUSTRIAL BATCH PERFORMANCE ANALYTICS,” both of which are incorporated by reference herein for all purposes. Indeed, the HMI system 70 may perform the root cause analysis and reference batch comparison operations described in the above-referenced applications while providing data packages as described herein to the generative AI system 90 via the generative AI backplane system 88 to allow users to interact with the generative AI system 90 and receive natural language responses related to the root cause analysis and reference batch operations. In some embodiments, the generative AI system 90 may provide recommend commands or operational modifications for one or more industrial automation components and the HMI system 70 may automatically or upon receiving user approval send the commands to the industrial automation components to modify operations, such that the root cause or reference batch issues are resolved, improved, addressed, or the like.

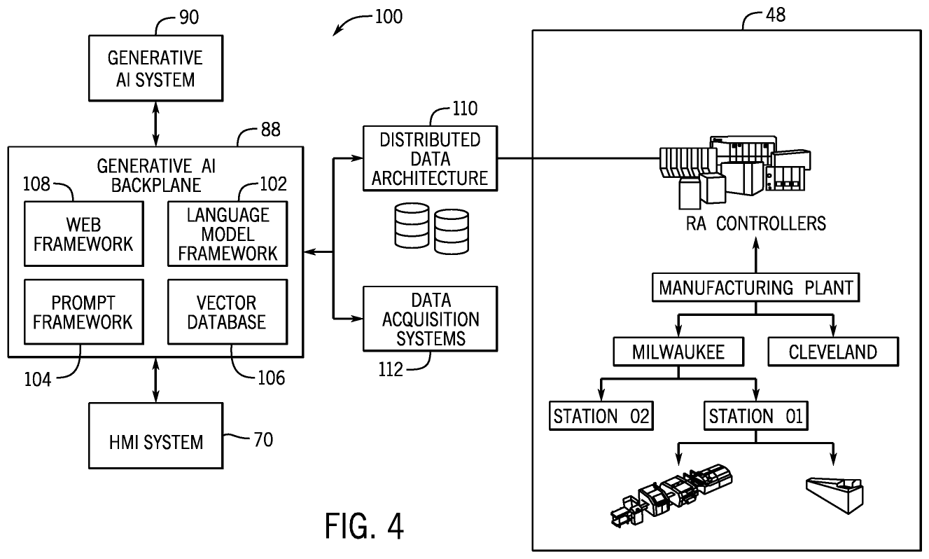

Referring now to FIG. 4, FIG. 4 illustrates industrial generative AI platform 100 that may include various components to perform the embodiments described herein. As will be described below, the industrial generative AI platform 100 may enable the HMI system 70 to access generative AI algorithms and models provided by the generative AI system 90 to deliver precise and contextually relevant responses to user inquiries regarding industrial automation systems and datasets recorded by or retrieved (e.g., in real time) via the distributed control system 48, industrial automation components, or the like. In this way, users may interact with a chatbot that supports natural language to enable intuitive communication between users and the generative AI system 90.

To facilitate the interaction between the generative AI system 90 and the HMI system 70 that may receive the user inputs, the generative AI backplane system 90 may include a number of sub-components or systems to perform various functions. For instance, the generative AI backplane system 90 may include a language model framework system 102 that may underpin or support the generative AI system 90 by providing packages or formatted datasets acquired via the distributed control system 48 or the like to the generative AI system 90 for efficient processing and for providing appropriate context to the inquiries that may be provided to the generative AI system 90 via the HMI system 70 or the like. The language model framework system 102 also facilitate dynamic chart or graph generative based on the output or feedback provided by the generative AI system 90. In this way, the language model framework system 102 may assist in deriving actional insights (e.g., commands or instructions for industrial components) from the provided datasets to aid in investigation of root cause analysis and other operations. In some embodiments, the language model framework system 102 may include a LangChain framework that enables inquiries and applications to become context aware by connecting a language model that may be implemented by the generative AI system 90 to sources of context, such as the datasets acquired via the industrial system. In some embodiments, the language model framework system 102 may receive, for instance, prompt instructions or examples, from a prompt framework system 104, which may also be part of the generative AI backplane system 88, to enable the generative AI system 90 to establish a context or domain (e.g., batch manufacturing/processing, mining industries, food beverage systems) that it may be unfamiliar with.

Indeed, the language model framework system 102 may receive pre-defined prompts that may be stored or provided to the prompt framework system 104 via data files, user input, or the like. The prompts may include a prompt template structure for expected inquiries that may be tailored for executing certain root cause analysis analytics, initial data anomaly investigations, and the like. The prompts may provide context to inquiries relative to datasets that may be provided via the distributed control system 48 or the like. The prompt structure data may also provide a response structure that corresponds to a format or structure in which the generative AI system 90 may provide responses to received inquiries relative to the datasets related to the industrial automation system. In some embodiments, the prompts may be pre-generated and provide via the HMI system 70 or may be monitored over time and tracked based on frequencies or prompt use and the like. The previous uses of prompts may provide insight with regard to relationships between the prompts, the relevant datasets, a particular domain or context, an expected answer format, and the like.

With this in mind, the language model framework system 102 may establish a connection or relationship between the prompts, the data provided via the distributed control system 48, and the operations performed by the generative AI system 90. The relationship data may be stored as metadata or other data format in vector database 106. The vector database 106 may store vector data that may represent the relationship data as vectors with strength factors, directionality, and the like.

As mentioned above, the generative AI backplane system 88 may enable users to connect to the generative AI system 90 via the HMI system 70 through a web framework system 108, which may provide an application programming interface (API) that may provide WebSockets and other connections between the HMI system 70, the generative AI system 90, and other components. By way of example, the web framework system 108 may be a FastAPI framework or other suitable framework for integrating APIs, exposing endpoints between systems, and the like.

The datasets provided to the generative AI backplane system 88 may include historical data that may be provided via a distributed data architecture system 110 (e.g., FT DataMosaix), data acquisition systems 112 (e.g., FT Optix), and the like. The distributed data architecture system 110 may receive and store data in certain formats or structures to allow historical data to be stored in an efficient and searchable manner. As such, the distributed data architecture system 110 may include offline data that may be analyzed in accordance with embodiments herein. In addition, the data acquisition systems 112 may access real-time data (e.g., online data) that may be measured, calculated, or monitored via industrial automation components, the distributed control system 48, or the like. Indeed, in some embodiments, certain connectors may ingest real-time sensor data and simulation data on an edge device, the industrial automation component, or the like to enable real-time analysis.

Referring again to the language model framework system 102, the language model framework system 102 may structure the inquiry with context provided via the datasets received via the distributed data architecture system 110 or the data acquisition systems 112 and the prompts received by the prompt framework system 104, such that the generative AI system 90 may use it's generative AI model to provide answers to the inquires with respect to the context provided by the language model framework system 102 in a structured manner that the user will be able to comprehend and appreciate with respect to the operations of the industrial automation system. In this way, the generative AI system 90 may have a mapping to domain specific datasets that are relative to the industrial system without continuously storing or having unlimited access to the respective datasets. As a result, the generative AI system 90 avoids certain pre-training processes to provide natural language responses using the context provided by the language model framework 102. Indeed, the generative AI system 90 conserves processing power and is enabled to perform natural language processing efficiently, while being leveraged with distinct datasets and contexts that it may not have received any training prior to receiving the inquiries.

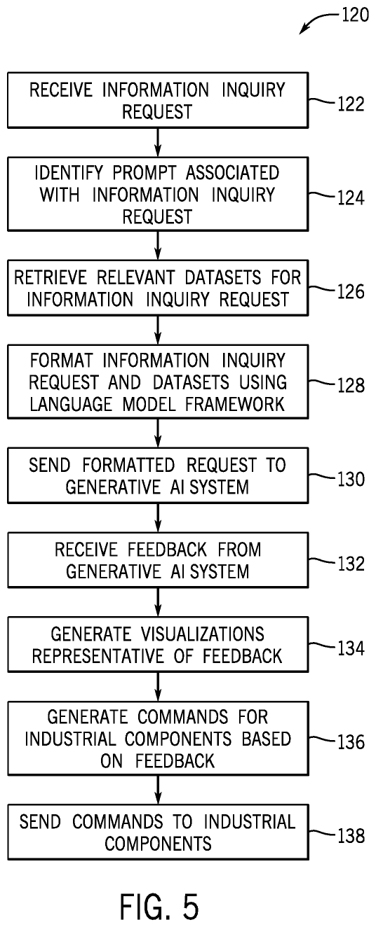

FIG. 5 illustrates a flow chart of a method 120 for providing generative AI systems 90 contextualized data to provide domain-specific output data for users, in accordance with embodiments presented herein. Although the following description of the method 120 will be discussed as being performed by the generative AI backplane system 88, it should be understood that any suitable system may perform the method 120 in any suitable order.

Referring now to FIG. 5, at block 122, the generative AI backplane system 88 may receive an information inquiry request. The information inquiry request may be received via a user input provided via the HMI system 70 or the like. The information inquiry request may correspond to a root cause analysis inquiry, a reference batch comparison, an operational feature of an industrial automation system, or the like. The information inquiry request may thus be related to or associated with datasets that may be acquired by the distributed control system 48, stored in a database, or the like. In some embodiments, the information inquiry request may be received as a natural language input.

At block 124, the generative AI backplane system 88 identify a prompt associated with the request. That is, the prompt framework system 104 may parse the request to identify a pre-defined prompt that may correspond to the request. In some embodiments, upon identifying the appropriate prompt based on similarities between the request and the respective prompt, the generative AI backplane system 88 may request a confirmation or update from the user via the HMI system 70. In any case, the identified or updated prompt may include metadata or structure data that identifies relevant datasets for resolving the request, a structure for receiving an answer to the request, and the like.

At block 126, the generative AI backplane system 88 may identify and retrieve relevant datasets associated with the request. As such, the generative AI backplane system 88 may query the distributed data architecture system 110, the data acquisition systems 112, or other suitable data source for the identified datasets. The generative AI backplane system 88 may query the data sources and receive the requested datasets.

After receiving the prompt structure, the answer structure, the relevant datasets, and other relevant information stored in the vector database 106, at block 128, the generative AI backplane system 88 may format the collected information into a package that may be parsed by the generative AI system 90. That is, the language model framework system 102 may package the data in format that provides the generative AI system 90 indications of the context, domain, and relationships between the request, the datasets, and the expected response or answer associated with the request. In this way, the generative AI system 90 may perform the natural language processing operations (e.g., applying GPT model) with respect to the context provided by the language model framework system 102. That is, the substantive portion of the analysis performed by the generative AI system 90 may focus on the data package provided by the language model framework system 102. In this way, the generative AI system 90 may provide more accurate responses to information requests in an efficient manner by focusing the operational tasks on the datasets and context provided by the language model framework system 102.

At block 130, the generative AI backplane system 88 may send the formatted dataset or data package to the generative AI system 90 to perform the analytical operations described above. In some embodiments, the data package provided to the generative AI system 90 may include root cause analysis data, batch comparison data, and other information that may be related to the operations of a respective industrial automation system.

At block 132, the generative AI backplane system 88 may receive feedback from the generative AI system 90. In some embodiments, the response may be provided in a format specified by the data package or the prompt framework system 104 as mentioned above. In this way, the user requesting the information may digest or understand the response because it is provided in the same context in which the prompt is organized.

At block 134. the generative AI backplane system 88 may generate visualizations representative of the response. That is, the generative AI system 90 may determine a suitable visualization (e.g., bar graph, line graph) in which the response may be presented to the user. In some embodiments, the generative AI system 90 may determine a suitable visualization based on models or historical data that indicate a threshold percentage of previous users' preference of visualization. In addition, the visualization may be determined based on user data related to the user providing the request and his/her preferences.

At block 136, the generative AI backplane system 88 may generate commands based on the provided response. That is, if the request is related to determining root cause or reference batch operations, the generative AI backplane system 88 may generate commands to issue to industrial automation components to cause the industrial system to operate in accordance with the request. As such, at block 138, after determining the commands, the generative AI backplane system 88 may send the commands to the respective industrial automation components via the distributed control system 48 or the like.

By performing the embodiments described herein, the HMI system 70 and the generative AI backplane system 88 may provide an augmentable library of pre-engineered prompts tailored for executing various domain-specific analysis including root cause analysis analytics, initial data anomaly investigations, and the like. Indeed, the generative AI system 90 may employ any suitable generative AI algorithms to deliver precise and contextually relevant responses to user queries, supporting natural language and enabling intuitive communication for users based on the packaged or structured datasets provided to the generative AI system 90 via the generative AI backplane system 88. As a result, the HMI system 70, the generative AI backplane system 88, the generative AI system 90, or other suitable device may generate dynamic visualizations based on AI analysis to derive actionable insights from data aiding in precise root cause identification in near-real time. The present embodiments include the ability to process online and offline data, ensuring comprehensive analysis regardless of the data source.

This integration of the generative AI system 90 (e.g., chatbot) with the user interface accessible via the HMI 70 would facilitate industry-wide application with intelligent root cause analysis for various domain-specific processes. For example, a library of pre-engineered prompts may be provided such that they are aligned with the root cause analysis scope to give users the ability to swiftly navigate and extract meaningful root cause analysis information from the datasets with natural language outputs.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving, via a processing system, a request for information associated with an industrial automation system from a user;
identifying, via the processing system, a prompt associated with the request;
identifying, via the processing system, one or more datasets associated with the request based on the prompt and the information;
receiving, via the processing system, the one or more datasets from one or more data sources;
formatting, via the processing system, the request and the one or more datasets into a package;
sending, via the processing system, the package to a generative artificial intelligence (AI) system; and
receiving, via the processing system, a response from the generative AI system, wherein the response is configured to be presented via a display of a human machine interface (HMI) system.

2. The method of claim 1, wherein the response comprises a visualization generative by the generative AI system based on the package.

3. The method of claim 1, wherein the request is updated based on the prompt.

4. The method of claim 1, wherein the prompt comprises metadata associated with an expected response format.

5. The method of claim 4, wherein the generative AI system is configured to generate the response based on the expected response format.

6. The method of claim 1, comprising:
generating one or more commands based on the response; and
sending the one or more commands to one or more industrial automation components of the industrial system, wherein the one or more commands are configured to cause the one or more industrial automation components to adjust one or more operations.

7. The method of claim 1, wherein the package is formatted by a language framework system.

8. The method of claim 1, wherein the language framework system comprises a LangChain system.

9. A non-transitory computer-readable medium comprising computer-executable instructions that, when executed, are configured to cause a processing system to perform operations comprising:
receiving a request for information associated with an industrial automation system from a user;
identifying a prompt associated with the request;
identifying one or more datasets associated with the request based on the prompt and the information;
receiving the one or more datasets from one or more data sources;
formatting the request and the one or more datasets into a package;
sending the package to a generative artificial intelligence (AI) system; and
receiving a response from the generative AI system, wherein the response is configured to be presented via a display of a human machine interface (HMI) system.

10. The non-transitory computer-readable medium of claim 9, wherein the generative AI system comprises a generative pre-trained model.

11. The non-transitory computer-readable medium of claim 9, wherein the request is updated based on the prompt via user input provided via the HMI system.

12. The non-transitory computer-readable medium of claim 9, wherein the prompt comprises metadata associated with an expected response format.

13. The method of claim 12, wherein the generative AI system is configured to generate the response based on the expected response format.

14. The non-transitory computer-readable medium of claim 9, comprising:
generating one or more commands based on the response; and
sending the one or more commands to one or more industrial automation components of the industrial system, wherein the one or more commands are configured to cause the one or more industrial automation components to adjust one or more operations.

15. The non-transitory computer-readable medium of claim 9, wherein the package is formatted by a language framework system.

16. The non-transitory computer-readable medium of claim 9, wherein the language framework system comprises a LangChain system.

17. The non-transitory computer-readable medium of claim 9, wherein the one or more datasets comprises real-time data.

18. A system, comprising:
one or more industrial automation components of an industrial system configured to perform a batch operation; and
a processing system configured to perform operations comprising:
receiving a request for information associated with an industrial automation system from a user;
identifying a prompt associated with the request;
identifying one or more datasets associated with the request based on the prompt and the information;
receiving the one or more datasets from one or more data sources;
formatting the request and the one or more datasets into a package;
sending the package to a generative artificial intelligence (AI) system; and
receiving a response from the generative AI system, wherein the response is configured to be presented via a display of a human machine interface (HMI) system.

19. The system of claim 18, wherein the request for information comprises a root cause analysis inquiry.

20. The system of claim 18, wherein the operations comprise:
generating one or more commands based on the response; and
sending the one or more commands to the one or more industrial automation components of the industrial system, wherein the one or more commands are configured to cause the one or more industrial automation components to adjust one or more operations.
